(19) United States
(12) Patent Application Publication
(10) Pub. No.: US 2019/0056017 A1
(43) Pub. Date: Feb. 21, 2019

(54) GEAR SYSTEM FOR ACHIEVING INFINITELY VARIABLE TRANSMISSION AND METHOD EMPLOYED THEREOF

(71) Applicant: ARUDRA VENKATT GYANI, Hyderabad (IN)

(72) Inventor: ARUDRA VENKATT GYANI, Hyderabad (IN)

(21) Appl. No.: 15/768,838

(22) PCT Filed: Oct. 28, 2016
(86) PCT No.: PCT/IB2016/056506

§ 371 Date: Apr. 17, 2018

(30) Foreign Application Priority Data
Oct. 31, 2015 (IN) 5897/CHE/2015

(51) Int. Cl. F16H 33/18

(52) U.S. Cl. CPC F16H 33/185

(57) ABSTRACT

A gear system for achieving an infinitely variable transmission comprising an input shaft for receiving rotational input into the transmission system and output shaft for delivering rotational output from the transmission system, a flywheel component for applying resistive forces of inertia into the transmission wherein the flywheel stores and stabilizes rotational energy in the transmission system, a high gear reduction mechanism achieved by assembly of one or more epicyclic gears wherein the flywheel accelerates with increasing difference of angular velocity between the input shaft and the output shaft, wherein the high gear reduction mechanism is based on the equation. (a)Z=(n+a)R−(n)X, where Z is angular velocity of flywheel, X is angular velocity of input shaft and R is angular velocity of output shaft, n & a are integer constants where a<<n or a<n. The gear ratios vary from 0 to 1, wherein another gear can be meshed with the output shaft to achieve overdrive gear ratios.

### TECHNICAL FIELD

The present disclosure generally relates to the field of transmission systems. More particularly, the present system relates to transmission systems and methods for achieving infinitely variable transmission.

### BACKGROUND

Modern manual transmissions have limited gear ratio variations and they depend on manual clutch mechanism to shift between gears, this affects both efficiency and driving comfort especially when speed is constantly varied. All present day designs of continuously variable transmission are friction based, the load they can carry is dependent on the frictional force between the moving parts of the continuously variable transmissions, which limits their use to light load applications. The automatic transmissions require computer assistance along with a clutch and band mechanism to engage and disengage gear ratios, rendering them complex and inefficient when gear ratios are continuously varied.

In the light of aforementioned discussion there exists need for a system and method that would ameliorate or overcome the above mentioned disadvantages.

Providing a system and method which addresses above issues by eliminating or reducing the use of clutch mechanism and improving the load limits. Ideally the load limit of this transmission is limited only by the tensile strength of the gear teeth. The transmission adjusts depending on the combination of input torque and vehicle speed, selecting best gear ratios and thus maximizing throughput with infinitely variable gear ratios. This infinitely variable transmission addresses issues of design complexities and production costs compared to other transmission technologies.

### BRIEF SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Exemplary embodiments of the present disclosure are directed towards a system and method for achieving an infinitely variable transmission.

According to an exemplary aspect of the present disclosure, the system includes an input shaft for receiving rotational input into the transmission system.

According to an exemplary aspect of the present disclosure, the system includes an output shaft for delivering rotational output from the transmission system.

According to an exemplary aspect of the present disclosure, the system includes a flywheel component for applying force of inertia into the transmission, wherein the flywheel stores and stabilizes rotational energy in the transmission system.

According to an exemplary aspect of the present disclosure, the transmission system requires a high gear reduction mechanism, wherein the flywheel rotates at high speed with respect to the input shaft when output shaft is non-rotational, similarly the flywheel rotates at high speed with respect to the output shaft when input shaft is non-rotational. Wherein the difference of angular velocity of input shaft and output shaft causes high angular acceleration in the flywheel. The high gear reduction mechanism is based on the gear ratio equation (a)Z=(n+a)R−(n)X, where Z is angular velocity of flywheel, X is angular velocity of input shaft, R is angular velocity of output shaft, ‘n’ & ‘a’ are integer constants where a<<n or a<n. The high gear reduction mechanism is achieved by an assembly of one or more epicyclic gears.

### BRIEF DESCRIPTION OF DRAWINGS

Other objects and advantages of the present invention will become apparent to those skilled in the art upon reading the following detailed description of the preferred embodiments, in conjunction with the accompanying drawings, wherein like reference numerals have been used to designate like elements, and wherein:

FIG. 1 is a flow diagram depicting a method for achieving the infinitely variable transmission using high gear reduction mechanism and a flywheel, according to exemplary embodiment of the present disclosure.

FIGS. 2A, 2B & 2C are diagrams depicting an example embodiment of the infinitely variable transmission system achieved by an assembly of epicyclic gears, according to exemplary embodiment of the present disclosure.

### DETAILED DESCRIPTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and the like, herein do not denote any order, quantity, or importance, but rather are used to distinguish one element from another.

According to non-limiting exemplary embodiment of the present disclosure, the system includes a flywheel for constant rotational energy, an input shaft for receiving rotational input from a prime mover and an output shaft to deliver output power from the transmission. The system further includes a high gear reduction mechanism connecting the input shaft, output shaft and the flywheel. The high gear reduction mechanism rapidly balances torque to and fro between flywheel and the output shaft. This is achievable using one or more epicyclic gears, wherein the gear ratios are based on the equation (a)Z=(n+a)R−(n)X, wherein Z is angular velocity of flywheel, R is angular velocity of output shaft, X is angular velocity of input shaft, a & n are integer constants with condition a<n or a<<n.

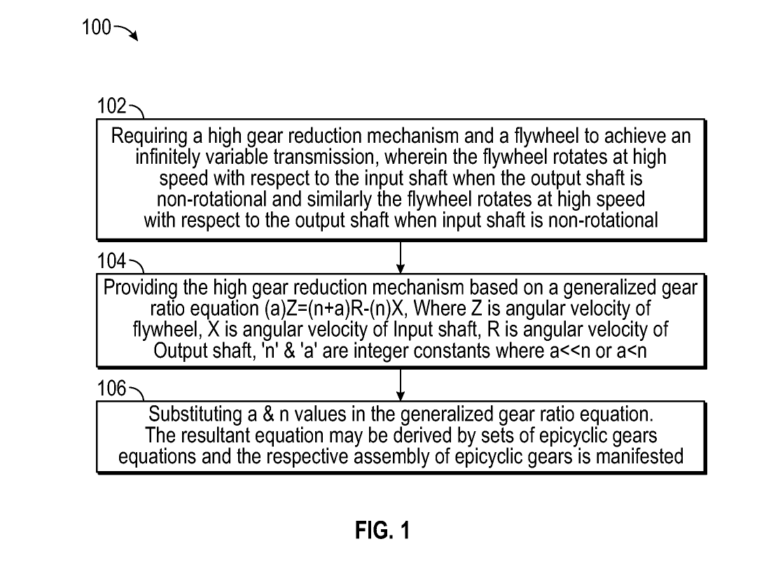

Referring to FIG. 1 is a flow diagram depicting a method for achieving the infinitely variable transmission system using epicyclic gears, according to exemplary embodiment of the present disclosure. The method starts at step 102 with the system requiring a high gear reduction mechanism and a flywheel to achieve an infinitely variable transmission, wherein the flywheel rotates at high speed with respect to the input shaft when the output shaft is non-rotational and similarly the flywheel rotates at high speed with respect to the output shaft when input shaft is non-rotational. The method continues to next step 104 by providing the high gear reduction mechanism based on a generalized gear ratio equation (a)Z=(n+a)R−(n)X, Where Z is angular velocity of flywheel, X is angular velocity of Input shaft, R is angular velocity of Output shaft, ‘n’ & ‘a’ are integer constants where a<<n or a<n. The method continues to next step 106 by substituting a & n values in the generalized gear ratio equation. The resultant equation can be derived by sets of epicyclic gears equations and the respective assembly of epicyclic gears is manifested.

According to non-limiting exemplary embodiment of the present disclosure, the equation of high gear reduction ratio can be obtained by substituting integer constants in the generalized gear ratio equation. The generalized gear ratio equation is,

(a)Z=(n+a)R−(n)X
Where Z—angular velocity of flywheel X—angular velocity of Input shaft
   R—Angular velocity of Output shaft
   n, a are integer constants (where a<<n or a<n)
      The assembly of epicyclic gears may be derived based on the resultant equation of high gear reduction ratio, after substitution of a,n values.

### Example 1

Substituting n=48, a=1 in the generalized gear ratio equation, (a)Z=(n+a)R−(n)X

The resultant gear ratio equation is:

Z=49R−48X

This equation may be achieved by an assembly of three epicyclic gears with gear ratio equations,

2Z+Y=3X first epicyclic

3Z+P=4R, P+Q=2R second epicyclic

16Y+11Q=27R third epicyclic
Where X—angular velocity of carrier gear of 1^{st} epicyclic gear(input shaft)
Y—Angular velocity of sun gear of the 1^{st} & 3^{rd} epicyclic gear
Q—angular velocity of planet gears in 2^{nd} & 3^{rd} epicyclic around its center of axis
R—angular velocity of common carrier of 2^{nd} and 3^{rd} epicyclic(output shaft)
P—angular velocity of sun gear of second epicyclic
Z—angular velocity of the common ring gear of 1^{st} & 2^{nd} epicyclic(flywheel)

### Example 2

Substituting n=20, a=1 in the equation, (a) Z=(n+a) R−(n) X results in gear ratio equation,

Z=21R−20X

This high gear reduction ratio may be achieved by an epicyclic gear having two ring gears with different number of gear teeth. The respective epicyclic gear ratio equations,

2Y+3Q=5X

3R+Z=4Q

Z+Y=2Q
Where X—angular velocity of second ring gear (input shaft) Y—angular velocity of planet gear around its own axis
Q—Angular velocity of the carrier gear connecting planets R—angular velocity of first ring gear (output shaft)
Z—Angular velocity of sun gear(flywheel)

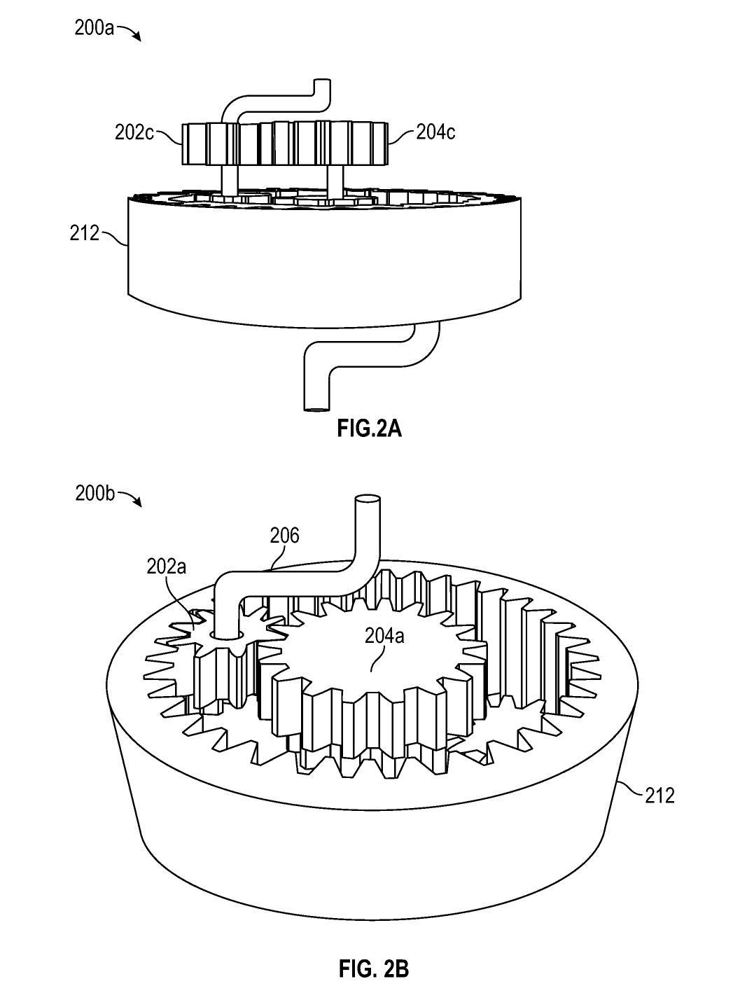

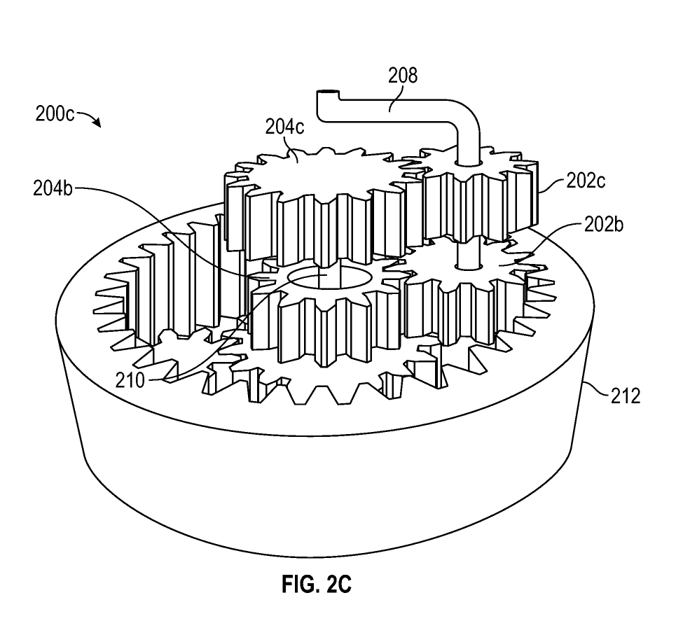

Referring to FIGS. 2A, 2B & 2C are diagrams 200a, 200b and 200c depicting an example of infinitely variable transmission, according to exemplary embodiment of the present disclosure, the example system includes the high gear reduction mechanism with gear ratio equation Z=49R−48X, which is achieved by three sets of epicyclic gears and the subsequent gear ratio equations 2Z+Y=3X, 3Z+P=4R, P+Q=2R, 16Y+11Q=27R. The first epicyclic gear ratio equation is 2Z+Y=3X, the second epicyclic gear ratio equations are 3Z+P=4R & P+Q=2R, the third epicyclic gear ratio equation is 16Y+11Q=27R. Where the input X is the carrier 206 connecting the planet gears 202a of the first epicyclic gear, the flywheel Z is the common ring gear 212 of first epicyclic gear and second epicyclic gear and Y is the sun gear 204a of first epicyclic gear that is connected through a shaft 210 to the sun gear 204c of third epicyclic gear, P is sun gear 204b of second epicyclic gear, the output R is connected to common carrier 208 connecting the planet gears 202b of second epicyclic gear and planet gears 202c of third epicyclic gear, and Q is the rotations of planet gears 202b& 202c around its center of axis which are connected.

According to non-limiting exemplary embodiments of the present disclosure, the system includes a flywheel component that applies force of inertia into the transmission. The flywheel component stores and stabilizes rotational energy into the infinitely variable transmission. The accelerating flywheel multiplies the torque acting on the output shaft and a decelerating flywheel gives a higher output shaft to the input shaft gear ratio, the flywheel adjusts to the speed of output shaft varying the gear ratio from low rpm & high torque to high rpm & low torque, giving the best gear ratios at all times. This flywheel gear may be meshed with another flywheel gear of the same size rotating in opposite direction to nullify pitching and rolling effects.

According to non-limiting exemplary embodiment of the present disclosure, in conventional manual transmission the approximate gear ratios (driveshaft RPM/engine RPM) in first gear is 0.34, second gear is 0.5, third gear is 0.75, fourth gear is 1, fifth gear is 1.15, sixth gear is 1.36. The approximate standard axle ratio (Driveshaft RPM/Wheel RPM) is 3.4, so the wheel rotates 1 time for every 3.4 rotations of the driveshaft. The resultant approximate gear ratio (Wheel RPM/Engine RPM) ranges from 0.1 in 1st gear to 0.4 in 6th gear. Thus for every rotation of engine the wheel rotations vary from 0.1 to 0.4. If there is no gear reduction from drive shaft to axle, that is when the axle ratio is 1, then there is no requirement of engaging overdrive gears in the transmission as this infinitely variable transmission has output shaft to input shaft gear ratios varying between 0 to 1. If there is gear reduction from driveshaft to axle then another low radius gear can be meshed with the output shaft gear to achieve overdrive gear ratios.

Although the present disclosure has been described in terms of certain preferred embodiments and illustrations thereof, other embodiments and modifications to preferred embodiments may be possible that are within the principles and spirit of the invention. The above descriptions and figures are therefore to be regarded as illustrative and not restrictive.

Thus the scope of the present disclosure is defined by the appended claims and includes both combinations and sub combinations of the various features described herein above as well as variations and modifications thereof, which would occur to persons skilled in the art upon reading the foregoing description.

What is claimed is:

1. A gear system for achieving an infinitely variable transmission comprising,
an input shaft for receiving rotational input into the transmission system;
an output shaft for delivering rotational output from the transmission system;
a flywheel component for applying resistive forces of inertia on the transmission, wherein the flywheel also stores and stabilizes rotational energy into the transmission system;
a high gear reduction mechanism wherein the flywheel rotates at high speed with respect to the input shaft when output shaft is non-rotational, similarly the flywheel rotates at high speed with respect to the output shaft when input shaft is non-rotational, wherein the high gear reduction mechanism is achieved by an assembly of one or more epicyclic gears, wherein the high gear reduction mechanism is based on the equation, (a)Z=(n+a)R−(n)X
where, Z is angular velocity of flywheel,
X is angular velocity of input shaft and
R is angular velocity of output shaft,
n & a are integer constants where a<<n or a<n

2. A method comprising,
requiring a flywheel and a high gear reduction mechanism to achieve an infinitely variable transmission system, wherein the flywheel rotates at high speed with respect to a input shaft when a output shaft is non-rotational, similarly the flywheel rotates at high speed with respect to the output shaft when the input shaft is non-rotational;
providing the high gear reduction mechanism based on a gear ratio equation (a)Z=(n+a)R−(n)X, Where Z is angular velocity of flywheel, X is angular velocity of Input shaft, R is angular velocity of Output shaft, ‘n’ & ‘a’ are integer constants where a<<n or a<n;
substituting a & n values results in a high gear reduction equation which can be achieved by a set of epicyclic gear ratio equations. The respective high gear reduction mechanism can be achieved by an assembly of the respective epicyclic gears and the assembled system could be manifested;
